(19) United States
(12) Patent Application Publication
(10) Pub. No.: US 2024/0339792 A1
(43) Pub. Date: Oct. 10, 2024

(54) COAXIAL BOARD CONNECTOR WITH AN IMPROVED INNER CONDUCTOR

(71) Applicants: FUDING PRECISION COMPONENTS (SHENZHEN) CO., LTD., Shenzhen (CN); FOXCONN INTERCONNECT TECHNOLOGY LIMITED, Grand Cayman (KY)

(72) Inventors: DE-JIN CHEN, Shenzhen (CN); SHIH-WEI HSIAO, New Taipei (TW)

(21) Appl. No.: 18/623,429

(22) Filed: Apr. 1, 2024

(30) Foreign Application Priority Data
Apr. 4, 2023 (CN) 202310390693.9

(51) Int. Cl. H01R 24/50; H01R 103/00

(52) U.S. Cl. CPC H01R 24/50; H01R 2103/00

(57) ABSTRACT

A coaxial board connector includes: a first outer conductor; a first insulator received in the first outer conductor and having an inserting opening and a receiving cavity; an inner conductor having a tail portion and plural elastic arms; and a second outer conductor having a lower fixing portion, a lower end of the first outer conductor connecting with the second outer conductor and being able to sway in the second outer conductor; wherein the elastic arms extend in the receiving cavity, each elastic arm has a contacting portion bending toward a central axis of the inner conductor and an end portion extending from the contacting portion, the end portions are retained in the first insulator to enable the elastic arms to sway together with the first insulator relative to the second outer conductor.

### BACKGROUND OF THE INVENTION

### Field of the Invention

The present invention relates to a coaxial board connector.

### Description of Related Arts

China Patent No. 218386036U discloses a floating radio frequency connector which comprises a fixing shell to be fixed on a printed circuit board, a floating outer conductor, an insulator, and a floating inner conductor. The combined unit of the insulator and the floating inner conductor is connected with the fixing shell and can move relative to the printed circuit board. The inner conductor cannot freely sway in the insulator as the inner conductor is firmly fixed in the insulator by plural latches thereof. There is often poor contacting between the inner conductor and a contact of a mating connector when the insulator sways to an inappropriate angle relative to the fixing shell.

Therefore, it is desired to provide a coaxial board connector with an improved inner conductor.

### SUMMARY OF THE INVENTION

An object of the present invention is to provide a coaxial board connector with an improved inner conductor.

To achieve the above object, a coaxial board connector comprises: a coaxial board connector comprising: a first outer conductor; a first insulator received in the first outer conductor, the first insulator having an inserting opening on an upper face thereof and a receiving cavity communicating with the inserting opening; an inner conductor comprising a tail portion for fixing on a printed circuit board and plural elastic arms; and a second outer conductor comprising a lower fixing portion for mounting on the printed circuit board, a lower end of the first outer conductor connecting with the second outer conductor and being able to sway in the second outer conductor; wherein the elastic arms extend in the receiving cavity, each elastic arm has a contacting portion bending toward a central axis of the inner conductor and an end portion extending from the contacting portion, the end portions are retained in the first insulator to enable the elastic arms to sway together with the first insulator when the first insulator sways with the first outer conductor relative to the second outer conductor.

Other advantages and novel features of the invention will become more apparent from the following detailed description of the present embodiment when taken in conjunction with the accompanying drawings.

### BRIEF DESCRIPTION OF THE DRAWING

FIG. 1 is a top perspective view of a coaxial connector assembly including a board connector and a device connector disconnecting from each other;

FIG. 2 is a bottom perspective view of the coaxial connector assembly wherein the board connector and the device connector are mated with each other;

FIG. 3 is a top perspective view of the board connector of FIG. 1;

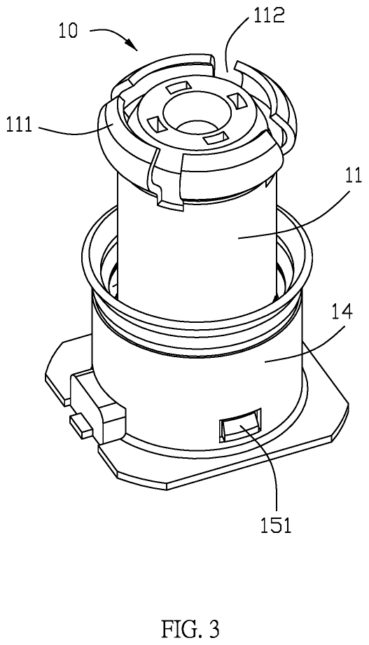

FIG. 4 is an exploded perspective view of the board connector of FIG. 3;

FIG. 5 is a further exploded perspective view of the board connector of FIG. 4;

FIG. 6 is a cross-sectional view of the board connector taken along line A-A of FIG. 1;

FIG. 7 is a cross-sectional view of the coaxial connector assembly taken along line B-B of FIG. 1; and

FIG. 8 is a cross-sectional view of the coaxial connector assembly taken along lines C-C.

### DETAILED DESCRIPTION OF THE PREFERRED EMBODIMENT

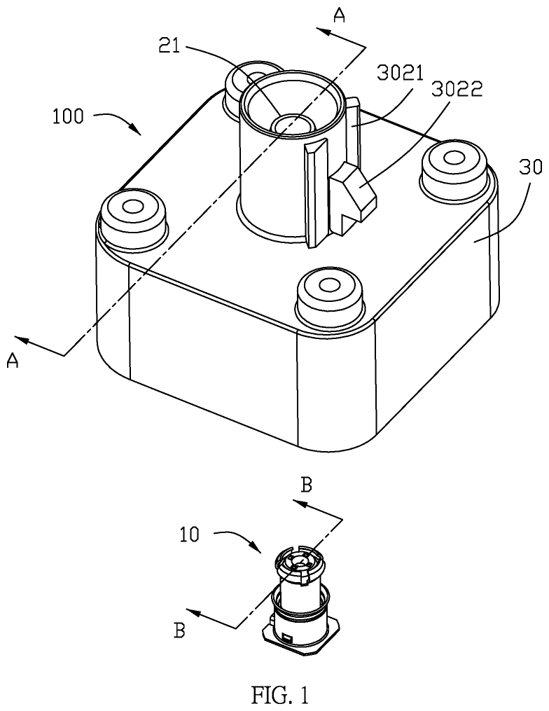

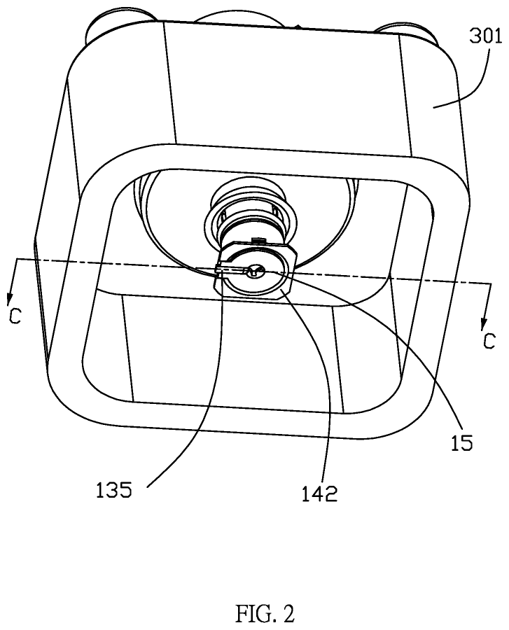

Referring to FIGS. 1-2 and 7-8, a floating coaxial connector assembly 100 used in a vehicle for transmitting signals from cameras, is illustrated. In a field of vehicle connectors, a Fakra plug connector is usually retained in a device case and is named as a device connector and a Fakra receptacle connector is fixed on a printed circuit board and is named as a board connector. The coaxial connector assembly 100 in this embodiment includes a board connector 10 and a device connector 20 embedded in a device case 30. When the device connector 20 and the board connector 10 are mated with each other, the board connector 10 together with the circuit board 40 is received in the device case 30. As the board connector 10 is a floating connector, it can slightly float relative to the mated device connector 20 to adapt for vehicle vibration.

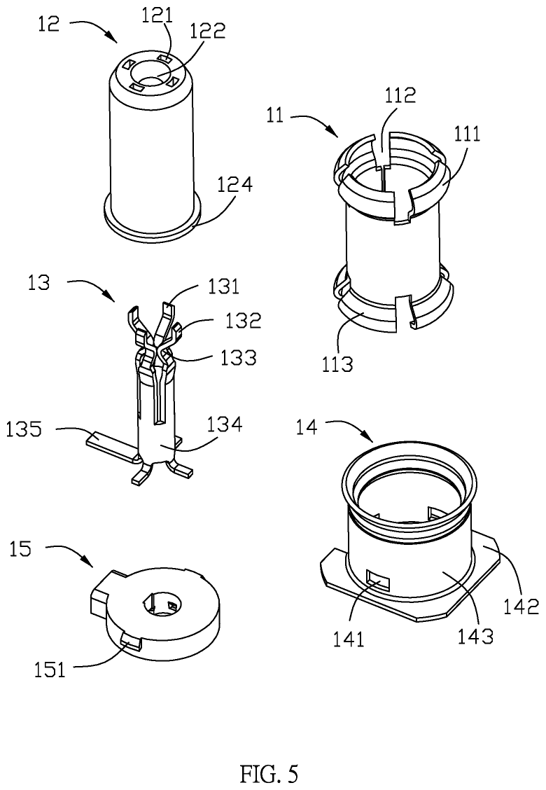

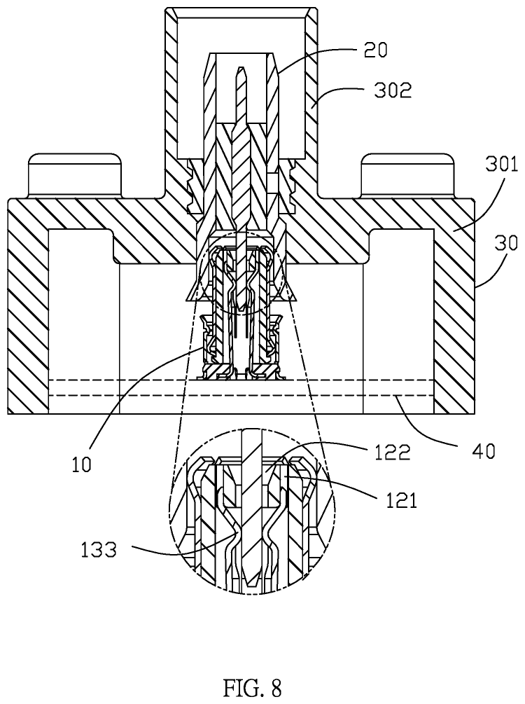

Referring to FIGS. 1 and 5-6, the board connector 10 comprises a first outer conductor 11 or an upper outer conductor, a first insulator 12 or an upper insulator retained in the first outer conductor 11, an inner conductor 13, a second outer conductor 14 or a lower outer conductor, and a second insulator 15 or a lower insulator retained in the second outer conductor 14. The second outer conductor 14 is fixed on the printed circuit board 40 (seen in FIG. 8). The first outer conductor 11 is assembled and floatably connected with the second outer conductor 14. The first insulator 12 has an inserting opening 122, plural retaining slots 121 around the inserting opening 122 and a receiving cavity 123 below and communicating with the inserting opening 122 and the retaining slots 121. The inner conductor 13 has a plurality of elastic arms 132 along a circumferential direction and at least one tail portion 135. Each elastic arm 132 has a contacting portion 133 and an end portion 131, and the contacting portion 133 bends toward a common center of the inner conductor 13. The end portion 131 extends outwardly from the contacting portion 133 and is fixed in the retaining slots 121 of the first insulator 12, thus, the elastic arms 132 can sway with the first insulator 11 when the first insulator 12 together with the first outer conductor 11 sways relative to the second outer conductor 14. The inner conductor 13 is in a shape of a tube and the first insulator 12 is in a shape of a column. The inner conductor 13 is coaxially received in the first insulator 12 and a lower end of the inner conductor 13 extends downwardly out from the first insulator 12. The clastic arms 132 are torn from an upper end of the inner conductor 13 and the tail portion 135 is formed by a lower end of the inner conductor 13 bending outwardly. The end portion 131 extends from the contacting portion 133 upwardly and outwardly. Preferably, the end portion 131 inclines from the contacting portion 133 upward and outward first, and then extends upright. The end portions 131 of the inner conductor 13 are received and retained in the retaining slots 121, thus, the end portion 131 can sway with the first insulator 12, making the elastic arm 132 elastically deformed. For making the first insulator 12 sway to the circuit board 40 fluently, a lower face of the first insulator 12 is defined as arc-shaped. A gap 125 is formed between the inner conductor 13 and an inside of the first insulator 12 or the receiving cavity 123, the inner conductor 13 can clastically deform in the gap 125 when the first insulator sways in an inappropriate angle relative to the second outer conductor 14, which can compensate for the poor contact between a central contact 23 of the device connector 20 and the inner conductor 13 caused by the inappropriate angle. In order to facilitate the elastic deformation of the elastic arm, the height of the elastic arm is larger than one third of that of the entire inner conductor 13.

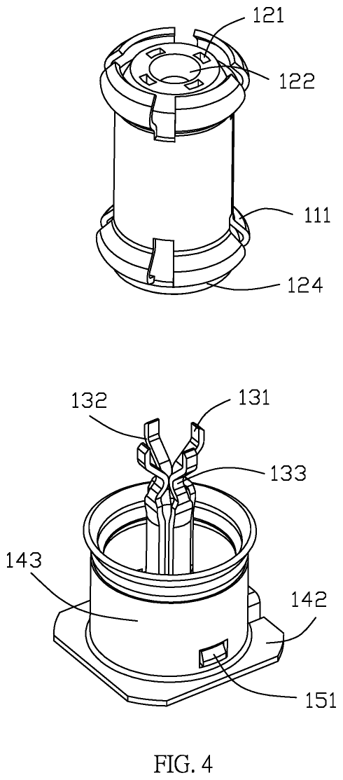

Referring to FIGS. 4-6, the first outer conductor 11 includes an upper mating portion 111 and a lower mating portion 113 respectively protruding outward along a circumferential direction of two ends thereof. The first outer conductor 11 electrically abuts against an inside of the second outer conductor 14 with the lower mating portion 113. A lower end of the first insulator 12 has a supporting portion 124 protruding circumferentially and having the arc-shaped lower face. The supporting portion 124 extends downwardly out of lower mating portion 113 of the first outer conductor 11 and supports the lower mating portion 113 upwardly. Preferably, the first outer conductor 11 and the first insulator 12 are integrally injection molded to ensure that they can sway synchronously. The second outer conductor 14 comprises a hollow cylindrical main portion 143 and a mounting portion 142, the second outer conductor 14 and the inner conductor 13 are coaxially mounted to the circuit board 40 with the main portion 143 surrounding outside the inner conductor 13. For better fixation of the inner conductor 13, the board connector 10 further includes a second insulator 15 fixed on the circuit board 40, the inner conductor 13 near its lower end is retained in the second insulator 15, the tail portion 135 extends out from the second insulator 15 and is fixed on the circuit board 40. The clastic arm 132 exposed to the receiving cavity 123 is located above the second insulator 15. The supporting portion 124 sits on an upper face of the second insulator 15, thus, the first outer conductor 11 together with the first insulator 12 can sway relative to the second insulator 15 under the action of the arc-shaped lower face thereof.

Referring to FIGS. 1-2 and FIGS. 7-8, the device connector 20 is received and retained in the device case 30, comprises the central contact 23, a shielding shell 21 and a third insulator 22. The shielding shell 21 is fixed in the device case 30 by a fixing ring (not labeled) between the shielding shell 21 and the device case 30, the fixing ring is integrally formed with the third insulator 22 by injection molding to unite the central conductor 23, the shielding shell 21 and the device case 30 as a whole. The device case 30 includes a base portion 301 and a cylindrical mating portion 302 extending upright from the base portion, the mating portion 302 has a buckle 3022 and plural guiding ribs 3021. Two ends of the central contact 23 are needle-shaped.

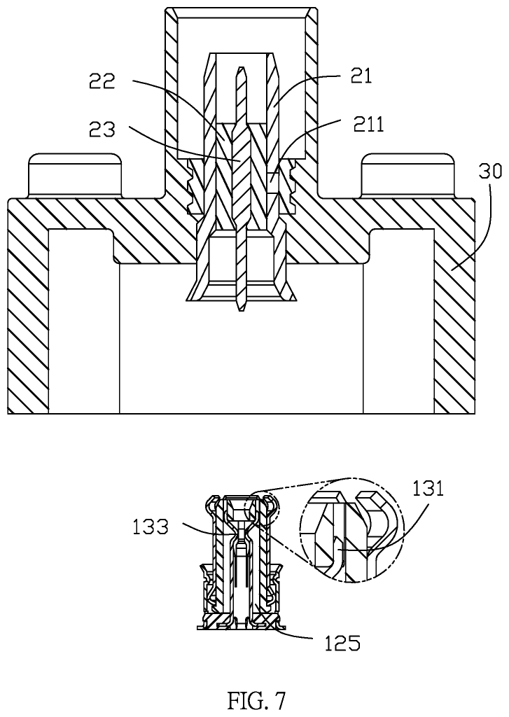

Referring to FIGS. 7-8, the first outer conductor 11 can sway with the first insulator 12 under the action of the arc-shaped lower face of the first insulator 12 when the board connector 10 is inserted into the device connector 20. Specifically, the first out conductor 11 together with the first insulator 12 sway under the action of an insertion force, thus, the contacting portion 133 of the inner conductor 13 can be offset as needed for better contacting with the central contact 23. The upper mating portion 111 has plural notches 112 circumferentially so as to be elastically held in the shielding housing 21.

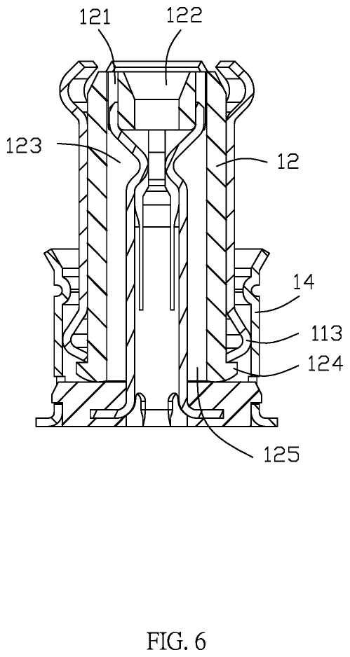

Referring to FIG. 6, in order to keep an offset of the first outer conductor 11 in a preset range, an inner diameter of the first insulator 12 is 1.2 to 2.0 times of that of the inner conductor 13. The second insulator 15 and the inner conductor 13 are integrally injection molded to ensure that they can be coaxially mounted to the circuit board 40. The second outer conductor 14 has plural locking holes 141 and the second insulator 15 has plural protruding bumps 151 which are received in corresponding locking holes 141. In order to make the inner conductor 13 sway within a predetermined amplitude, the ratio of the height of the inner conductor 13 in the second insulator 15 to that in the first insulator 12 is between 0.1 and 0.2.

Although the present invention has been described with reference to particular embodiments, it is not to be construed as being limited thereto. Various alterations and modifications can be made to the embodiments without in any way departing from the scope or spirit of the present invention as defined in the appended claims.

1. A coaxial board connector comprising:
a first outer conductor;
a first insulator received in the first outer conductor, the first insulator having an inserting opening on an upper face thereof and a receiving cavity communicating with the inserting opening;
an inner conductor comprising a tail portion for fixing on a printed circuit board and plural elastic arms; and
a second outer conductor comprising a lower fixing portion for mounting on the printed circuit board, a lower end of the first outer conductor connecting with the second outer conductor and being able to sway in the second outer conductor;
wherein the elastic arms extend in the receiving cavity, each elastic arm has a contacting portion bending toward a central axis of the inner conductor and an end portion extending from the contacting portion, the end portions are retained in the first insulator to enable the elastic arms to sway together with the first insulator when the first insulator sways with the first outer conductor relative to the second outer conductor.

2. The coaxial board connector as claimed in claim 1, wherein a gap is defined between the elastic arms and an inside of the receiving cavity, and a lower end of the first insulator extends out from a lower end of the first outer conductor and defines a curved lower face to guide the first insulator to sway.

3. The coaxial board connector as claimed in claim 1, comprising a second insulator retained in the second outer conductor, wherein a lower end of the inner conductor is embedded in the second insulator and the tail portion extends out from the second insulator, and the lower end of the first insulator sits on the second insulator.

4. The coaxial board connector as claimed in claim 1, wherein the elastic arm is torn from an upper end of the inner conductor which tube-shaped, and the end portion extends outwardly and upwardly from the contacting portion.

5. The coaxial board connector as claimed in claim 1, wherein the first insulator has plural fixing slots around the inserting hole through the upper face thereof, and each end portion is received in a corresponding fixing slot.

6. The coaxial board connector as claimed in claim 4, wherein a diameter of the first insulator is 1.2 to 2.0 times of that of the inner conductor.

7. The coaxial board connector as claimed in claim 3, wherein the second outer conductor has plural locking holes and the second insulator has plural protruding bumps received in corresponding locking holes.

8. The coaxial board connector as claimed in claim 3, wherein a ratio of a length of the inner conductor embed in the second insulator to that received in the first insulator is 0.1 to 0.2.

9. A coaxial board connector comprising:
an upper outer conductor having a lower mating portion;
an upper insulator fixed in the upper outer conductor, upper insulator having an inserting opening, plural retaining slots around the inserting opening, and a receiving cavity below the inserting opening and the retaining slots;
a lower outer conductor comprising an upper mating portion floatably connecting with the lower mating portion of the upper outer conductor and a board fixing portion; and
an inner conductor comprising plural elastic arms with contacting portions and a board fixing portion;
wherein an end portion extends upwards from the contacting portion and is retained in the retaining slot while other portions of the inner conductor is gapped from the receiving cavity of the first insulator.

10. The coaxial board connector as claimed in claim 9, wherein a height of the elastic arm is larger than one third of that of the inner conductor.

11. The coaxial board connector as claimed in claim 9, comprising a lower insulator below the upper insulator, wherein a lower end of the inner conductor and a lower end of the lower outer conductor are fixed in the lower insulator.

12. The coaxial board connector as claimed in claim 11, wherein the upper insulator has a supporting portion protruding circumferentially at a lower end thereof and having an arc-shaped lower face, the lower face sits on the lower insulator and is able to sway relative to the lower outer conductor.

13. The coaxial board connector as claimed in claim 12, wherein the lower mating portion protrudes outward along a circumferential direction thereof, the lower mating portion abuts against an inside of the lower outer conductor, and the supporting portion supports the lower mating portion upwardly.

14. A coaxial connector assembly comprising:
a printed circuit board;
a board connector being mounted on the printed circuit board and comprising:
a first outer conductor;
a first insulator retained in the first outer conductor and having a receiving cavity through an upper face thereof;
a tubular inner conductor received in the receiving cavity, the inner conductor having plural elastic arms each with a contacting portion protruding into the receiving cavity; and
a second outer conductor comprising a lower fixing portion fixed on the circuit board, the first outer conductor being able to sway relative to the second outer conductor;
a device case; and
a device connector received and retained in the device case, device connector comprising a central contact with a lower contacting portion;
a shielding shell; and
a third insulator securing the central contact in the shielding shell;
wherein the contacting portion of the central contact is inserted into and electrically connects with the contacting portions of the inner conductor;
wherein upper ends of the elastic arms are retained in the first insulator.

15. The coaxial connector assembly as claimed in claim 14, wherein a gap is defined between an outer face of the inner conductor and the inside wall of the receiving cavity to enable the elastic arm to deform freely therein.

16. The coaxial connector assembly as claimed in claim 14, wherein the shielding shell is fixed in the device case by a fixing ring which is integrally formed with the third insulator by injection molding to unite the central conductor, the shielding shell, and the device case as a whole.
